(19) United States
(12) Patent Application Publication
(10) Pub. No.: US 2015/0127422 A1
(43) Pub. Date: May 7, 2015

(54) Social Network Marketing System and Method

(71) Applicant: VIP Wink Corp, Fort Lauderdale, FL (US)

(72) Inventors: Steven M. Berman, Davie, FL (US); Steven Adelstein, Coral Springs, FL (US)

(21) Appl. No.: 14/529,846

(22) Filed: Oct. 31, 2014

Related U.S. Application Data
(60) Provisional application No. 61/898,800, filed on Nov. 1, 2013.

(51) Int. Cl. G06Q 30/02; G06Q 30/04

(52) U.S. Cl. CPC G06Q 30/0273; G06Q 30/04; G06Q 30/0201; G06Q 50/01
USPC 705/7.29; 705/14.69

(57) ABSTRACT

A system is disclosed for providing information including an interface for receiving the information from a source and a delivery channel for transmitting the information to a subscriber. The system may include a commerce component for monetization. The information may be at least partially exclusive. A method is described for transmitting information including receiving the information from a source, and transmitting the information to a subscriber.

### CROSS-REFERENCE TO RELATED APPLICATIONS

This application is a nonprovisional application of and claims priority from U.S. provisional patent application Ser. No. 61/898,800 filed on Nov. 1, 2013. The foregoing application is incorporated in its entirety herein by reference.

### FIELD OF THE INVENTION

The present invention relates to a marketing system and method. More particularly, the present invention relates to a marketing system and method using a social network.

### BACKGROUND

Over recent years, social networking has become an increasingly integrated aspect of modern culture and society. Individuals can monitor thoughts, interests, and events shared by celebrities using social networking platforms such as Twitter. However, as more individuals follow a celebrity, the exclusivity of the information gained from receiving the social networking updates from the celebrity becomes diminished.

What is needed is a system to receive information provided by a source that is exclusive to the transmission medium. What is needed is a system to receive information provided by a source that is a timed exclusive for the transmission medium. What is needed is a platform to monetize distribution of information to an exclusive subscriber base. What is needed is a method to provide exclusive access to information.

### SUMMARY

The present invention provides exclusive access to information provided by a source. The source may be a high profile source, such as a celebrity, athlete, comedian, business person, or other person of interest. Exclusivity may include absolute exclusivity, timed exclusivity, and/or other models of prioritization. Subscribers may pay an enrollment and/or subscription fee to access the information provided by the source.

The present invention provides a system to receive information provided by a source that is exclusive to the transmission medium. Additionally, the present invention provides a system to receive information provided by a source that is a timed exclusive for the transmission medium. The present invention also provides a platform to monetize distribution of information to an exclusive subscriber base. Moreover, the present invention includes a method to provide exclusive access to information.

According to an embodiment of the present invention, a system is provided for providing information including an interface, a delivery channel, and a commerce platform. The interface may be used for receiving the information from a source. The delivery channel may be used for transmitting the information to a subscriber. The commerce platform may be used for monetization. The information may be at least partially exclusive.

In another aspect, the commerce platform may include a billing engine to receive payment from the subscriber prior to providing access to at least part of the delivery channel.

In another aspect, the billing engine may generate revenue from the subscriber via a subscription to view the information from the source.

In another aspect, the subscriber may be provided access to a first subscription for a first subscription fee and a second subscription for a second subscription fee. The payment from the subscriber may include the first subscription fee and the second subscription fee.

In another aspect, being at least partially exclusive may include a delay period in which the subscriber has access to the information excluded from a non-subscriber. After the delay period, the non-subscriber may be provided the access to the information.

In another aspect, the commercial platform may further include an advertising platform to display an advertisement for an advertising fee paid by an advertiser.

In another aspect, the advertisement may be displayable in the delivery channel.

In another aspect, the interface may include a dashboard to display the information to the subscriber.

In another aspect, the dashboard may display information including trending content from sources.

In another aspect, the subscriber may be definable to have an elevated membership status that provides additional benefits.

In another aspect, data may be collected relating to the subscriber, wherein the data is presentable to the source, and wherein the data may be indicative of fan equity.

In another aspect, ownership of the information may be provided by the source and the data collected relating to the subscriber may be provided to the source.

In another aspect, the interface may include a browser to view media content without leaving the system.

In another aspect, feedback relating to exclusivity may be provided to the subscriber.

In another aspect, a communication feature may be included to open a channel of communication between the subscriber and the source.

According to an embodiment of the present invention, a system is described for providing information including an interface, a delivery channel, a commerce platform, and data. The interface may be provided for receiving the information that is at least partially exclusive from a source. The delivery channel may be provided for transmitting the information to a subscriber. The commerce platform may be provided for monetization including a billing engine and an advertising platform. The data may be collected relating to the subscriber. The data is presentable to the source. The data may be indicative of fan equity.

In another aspect, the source may be locatable by a non-subscriber.

According to an embodiment of the present invention, a method is provided for transmitting information. The method may include (a) receiving the information from a source. The method may also include (b) determining a subscriber to the source. The method may additionally include (c) transmitting the information to the subscriber. The information may be at least partially exclusive.

In another aspect, the method further includes (d) providing feedback relating to exclusivity to the subscriber.

In another aspect, the method further includes (e) opening a channel of communication between the subscriber and the source.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a flowchart illustrating exclusively distributing information, according to an embodiment of the present invention.

FIGS. 2-3 include screenshots illustrating aspects of the interface, according to an embodiment of the present invention.

FIGS. 4A-4E is a flowchart illustrating an interface for a content provider, according to an embodiment of the present invention.

FIGS. 5A-5E is a flowchart illustrating an interface for a user, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a system and method for facilitating the distribution of information across a socially connected information network. For example, the system may include a platform to provide information to an exclusive group of subscribers. The information may have differing levels of exclusivity, including absolute exclusivity, timed exclusivity, or other types of exclusivity. An indicator may be included in an interface reflecting a type of exclusivity being used. The system may additionally allow a source to benefit from its fan equity via data collection, promotions, and marketing features.

The system may be operated using a computerized device. The computerized device may include a processor and memory, and may be accessible via an interface. The computerized device may be connected to other computerized devices via a network, for example, the internet.

The system may include a database to store user profiles, profile related information, and other information that may be used by the system. The database may be accessible via a network, for example, the internet. The database may be a SQL based database, for example, MySQL, Cassandra, or another database structure. The database may also be remotely hosted, for example, via Amazon's Relational Database Service (RDS), which is operable by Amazon's Elastic Compute Cloud (EC2) Skilled artisans will appreciate additional database and cloud computing services and operations that may be used with the preset invention.

Initial data for subscriber access and channels related to sources may utilize cloud-based technologies. The cloud-based technologies may be partnered or accessed via third party services, for example and without limitation, Amazon's EC2 services.

The system may also operate, for example, using virtual application servers. An example of a virtual application server that could be used includes Amazon's Elastic Beanstalk. Elastic Beanstalk makes deployments a breeze and provides built in load balancing and auto scale capabilities. Elastic Beanstalk also allows the infrastructure to automatically scale up and down to meet the changing demand of the system. For this type of application, the system may use at least three large EC2 servers, which may be geographically distributed due to the high volume of requests that could be received by the system. By providing an adequate server capacity, the system could avoid experiencing excessive denied requests that may due to overwhelmed server resources, which could block the requests coming from the system. An example of a geographically distributed server system may include servers spread the load of the system across numerous locations, such as with servers located in US East, US West at Northern California, and US West at Oregon.

The system may integrate communications made over a social network, such as, but not limited to, Twitter. In another embodiment, the system may supplant or replace a competitor social network. The system may utilize several key integration technologies to provide scalability. The system may also include a billing engine to provide recurring billing using traditional and micro payment interfaces, along with other payment interfaces.

The system may include a mobile application component, which may be operated on a personal electronic device such as a smartphone or other computing device. The mobile application component may be operable of a mobile operating system, for example, Apple iOS or Google Android OS. The mobile application component may be downloaded and installed for an online marketplace, which may be provided by the mobile operating system. The mobile application component may be at least partially integrated with the mobile operating system. Skilled artisans will appreciate additional operating environments beyond mobile platforms through which the system may be operated that are consistent with the scope and spirit of the present invention.

The system may be optimized for additional devices, for example, desktop computers, notebooks, tablets, and other devices. Tablet optimization will now be discussed as an example, and without limitation. The interface may be optimized for a tablet, such as an Apple iPad, Windows-based tablet, Amazon Kindle, or Android-based tablet. An application for the system may be downloaded via an online storefront for the operating system of the tablet. The tablet application may be optimized for one or more screen sizes, for example, between 6″-13″ screen sizes. Interaction with the application dashboard may be conducted via an input method of the tablet, for example, touch.

The mobile application component may also integrate with a social networking platform. For example, the mobile application platform may integrate with notification components of Twitter and/or the system of the present invention.

Services of the system may be provided to subscribing users. For example, prior to using the system, a user may be required to sign up for the service using an interface, such as a webpage. The webpage interface may include code that uses HTML5 or another web-based interface code base. The interface may include a search function.

The system may include a commerce platform to provide monetization from the service. The commerce platform may include various engines and components to monetize the services provided by the system, including a billing engine and an advertising platform. For example, the billing platform may bill a subscriber a one-time charge, monthly recurring charges, or otherwise calculated charges for access to the service. One illustrative billing structure may include $0.99/month for each source to which the subscriber monitors, without limitation. The billing engine may charge a subscriber using a commerce platform that may optionally be integrated into the system. Alternatively, the system may engage an external commerce platform. In one embodiment, the system may bill a subscriber to automatically withdraw an amount via a credit card or withdrawal account provided by the subscriber. In another embodiment, the system may bill a subscriber through an intermediary service platform, such as an application store or software distribution system.

In an illustrative embodiment, the subscriber may be charged a monthly fee billed annually. For example, this approach may allow for the billing of a currently proposed $0.99 monthly fee on an annualized basis ($11.88 annually). By using a subscription model, the system may substantially avoid any additional fees being paid to the various marketplace stores Skilled artisans will appreciate that the pricing of this model may be modified at virtually any time, for example, up to 4 times per month, without limitation. Users may be required to enter a key to access the exclusive network. The key may be related to a license. The key be sold separately outside of a marketplace wherein the mobile interface component was acquired. In one example, a subscriber may subscribe to a first subscription and a second subscription. Each of the first and second subscriptions may be associated with a respective first and second subscription fee, which my both be collected for payment Skilled artisans will appreciate additional subscriptions and respective fees may be subscribed by and paid for by a subscriber.

Monthly reporting and payments may be made to sources, such as high profile content providers including celebrities. The monthly payments to the high profile content providers may be paid out at an effective rate over time, for example, a 1/12 rate. This high profile content provider payment structure may allow an operator of the system to retain the maximum amount of cash for working capital during growth. Skilled artisans will appreciate additional and similar payment structures for other sources after having the benefit of this disclosure. Payments made to sources, such as the high profile content providers, may be made using a commerce platform as described above.

Following user sign up, the system may route premium content provided by one or more source, such as the high profile content provider, to the assigned social networking feed per normal usage via the social network. The social networking feed may be provided by a third party social networking service, for example, Twitter.

The system may advantageously provide monetization of an operating company by capturing interest in a critical mass of sources, such as celebrities, with large social network following, such as a Twitter following. This critical mass may be captured by showing the sources an easy to operate and substantially seamless application that is usable to generate and provide exclusive information and updates to his or her subscribers. Additionally, sources are enticed to participate in the system by receiving payments for the delivery of information or a message to the subscribers. Sources, such as high profile content providers, or an assigned charity designated to benefit on behalf of the source, may receive payment relative to the interest in the source's feed by subscribers. For example, the source may receive monetary benefit through a simple content delivery channel selection allowing for delivery of premium content. The source may receive payment after the content has been delivered to a definable number of subscribers, for example, and without limitation, ten paid subscribers.

A utility backend module may be included with the system for management of the system. Additional requirements may be added to longer-term strategic goals of the system. For example, the system may be scalable to include additional operational social networking platforms. Additionally, the system may be expanded to include full social media integration, cross-marketing options, bi-direction fee based fan to celebrity tweets, and affiliate participation between sources, such as celebrities. These roadmap controls may be managed through commercial platform integration, which may handle all aspects of CRM, billing, and reporting.

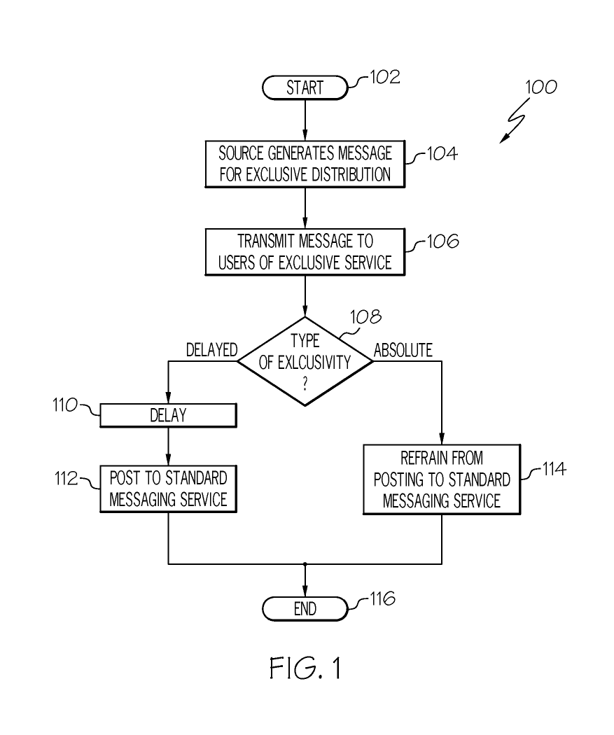

Referring now to flowchart 100 of FIG. 1, an illustrative method operable to deliver exclusive messages will now be discussed. Starting at Block 102, the method may include a source generating a message, which may be labeled for exclusive distribution. (Block 104). The message may be transmitted to subscribers of the exclusive service. (Block 106). The method may include determining a type of exclusivity to be applied to the message. (Block 108). In the interest of simplicity, the present example includes delayed and absolute exclusivity options. If it is determined at Block 108 that the delayed exclusivity is applied, the method may include delaying transmission of the message to other social media networks for a delay period. (Block 110). After the delay period has expired, the message may be transmitted to the other social media networks. (Block 112). If it is determined at Block 108 that absolute exclusivity is to be applied, the method may include refraining from positing the message to other social media networks. (Block 114). The method may then terminate at Block 116.

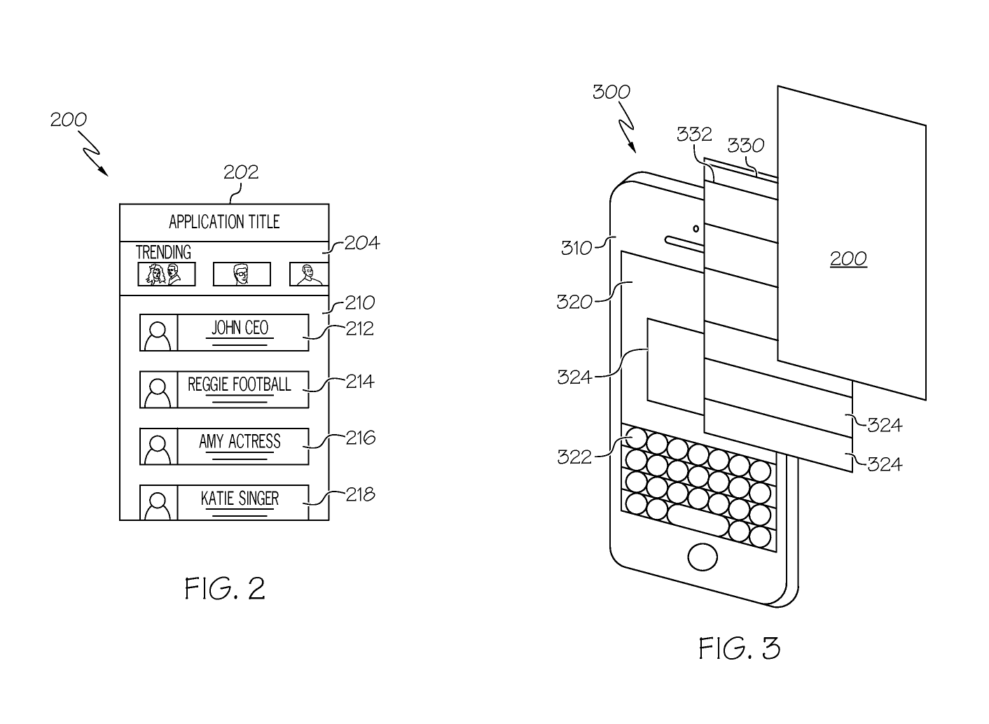

Referring now to diagrams 200 and 300 of FIGS. 2 and 3, various illustrative screens of an interface are shown. Diagram 200 of FIG. 2 illustrates an illustrative screen of the interface displaying a title 202 for the application, trending content, news, topics, and/or related sources to follow 204, and a list of sources 210 available for subscription using the service. Entries in the list of sources may include a photograph or headshot, name, brief description of the source, number of subscribers, and other information. Example sources shown in this list include a business icon 212, athlete 214, actor/actress 216, and musician 218. The list of sources 210 may be scrollable to display additional sources.

Diagram 300 of FIG. 3 illustrates additional screens of an interface that can be displayed on an electronic device 310. The screens may include a text entry screen 320 that include a text box 324 and virtual keyboard 322. The screens may additionally include a list of subscribed sources 330, which may include a title for a group of sources 332 and updates for multiple subscribed sources 324. The interface may also include the illustrative screen 200 discussed above. Skilled artisans should appreciate that the interface may vary in application from the example provided by FIGS. 2 and 3, without limitation. The interface may include a search function.

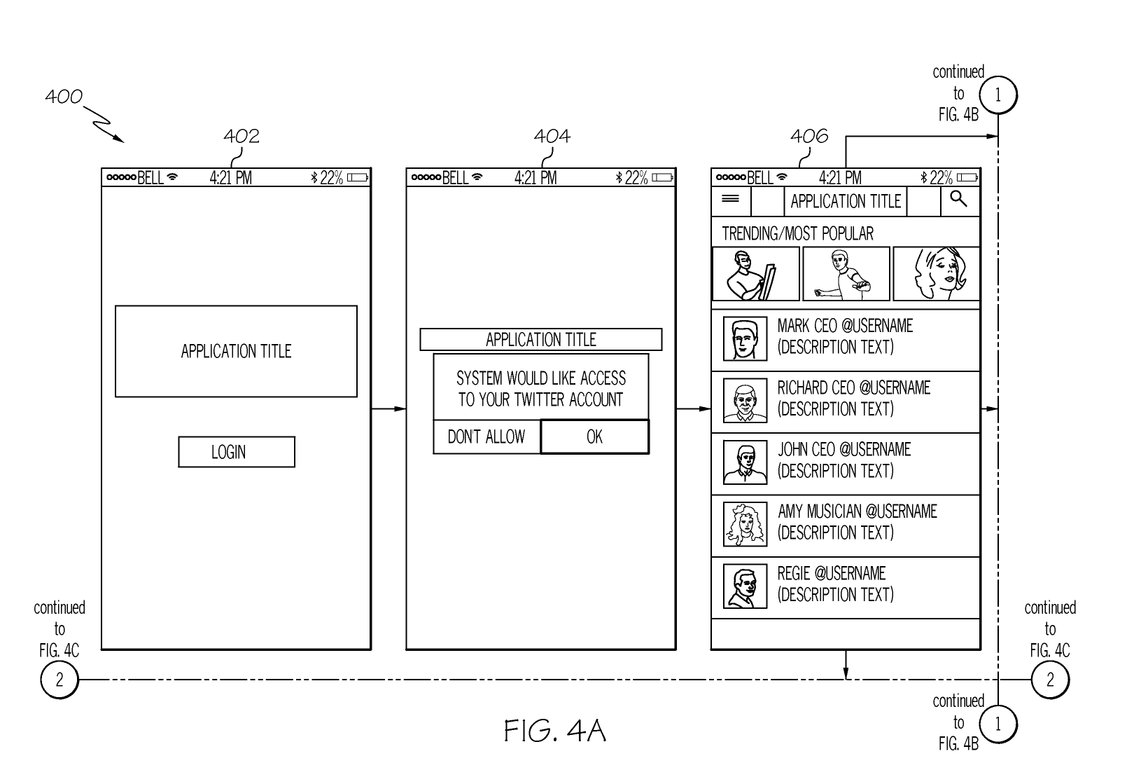

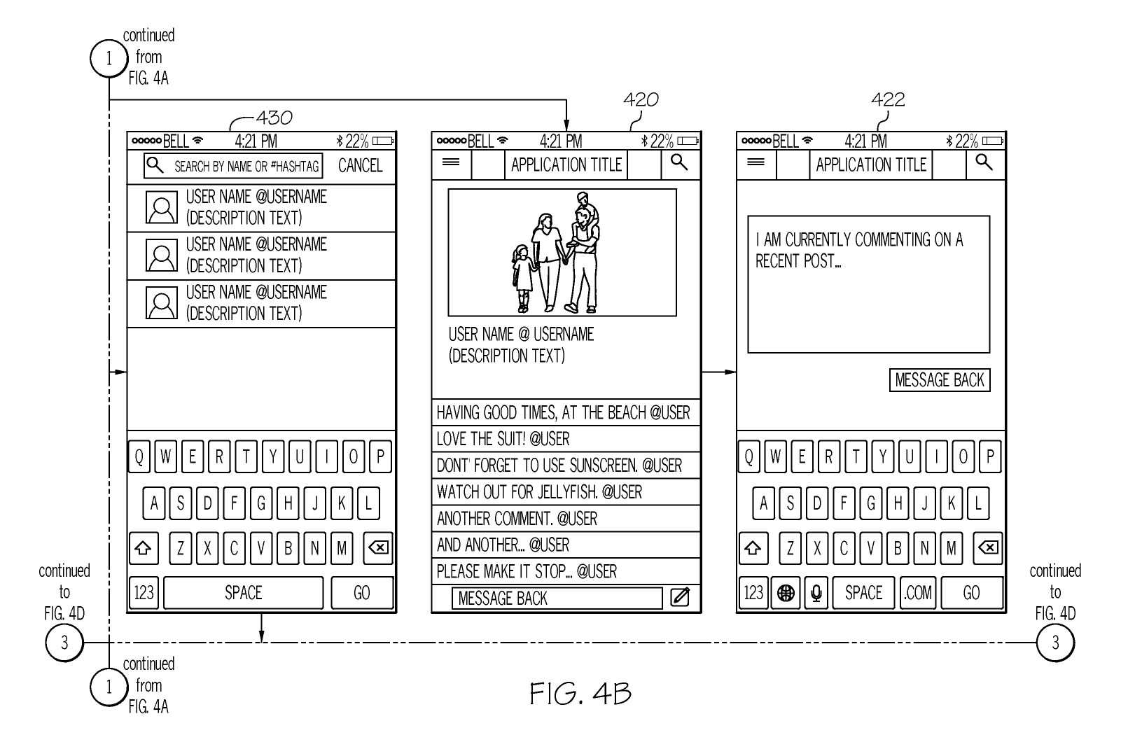

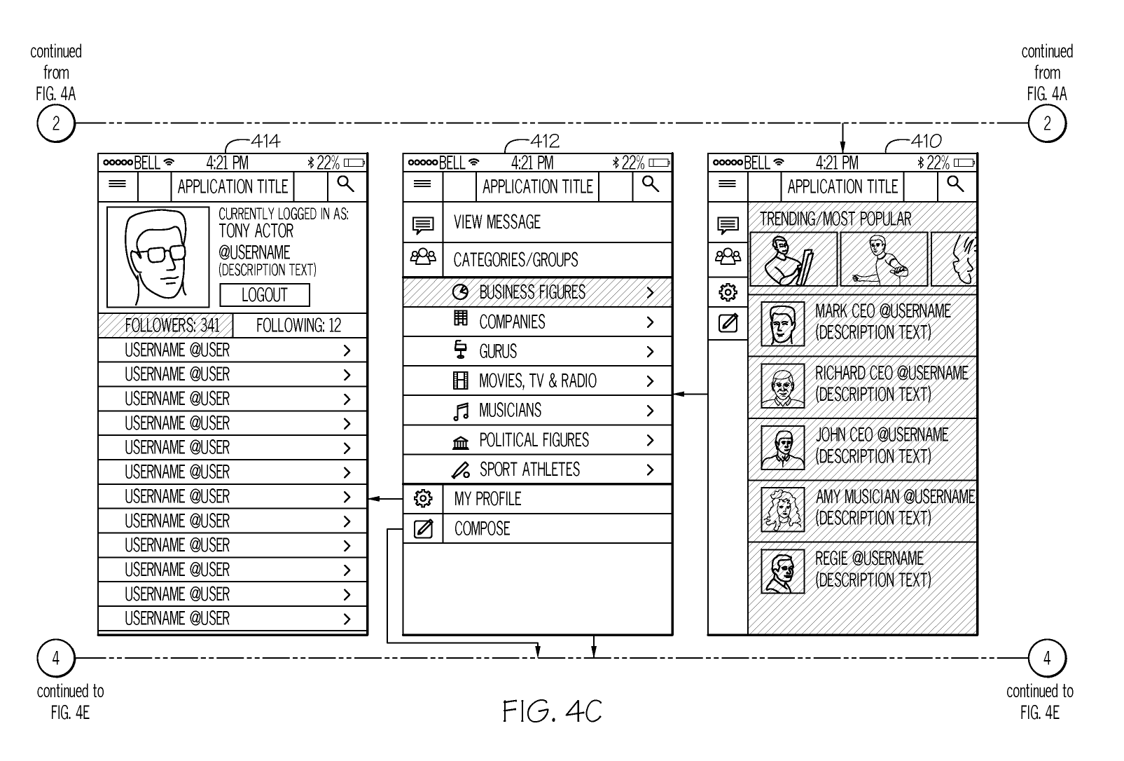

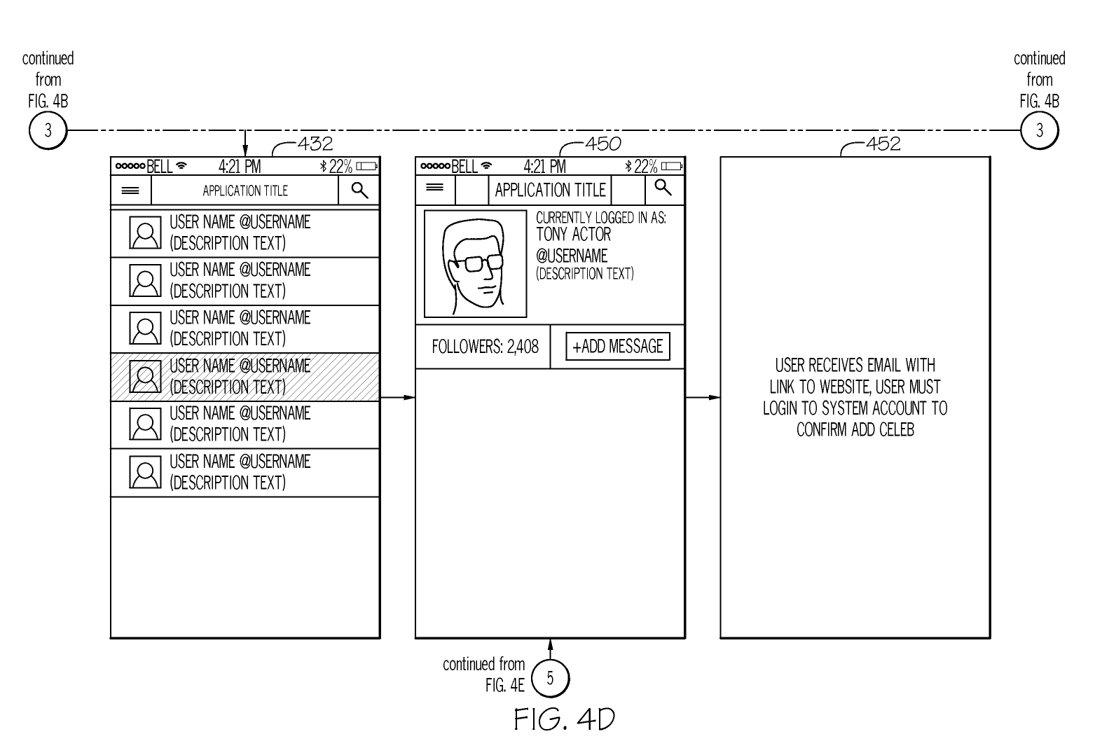

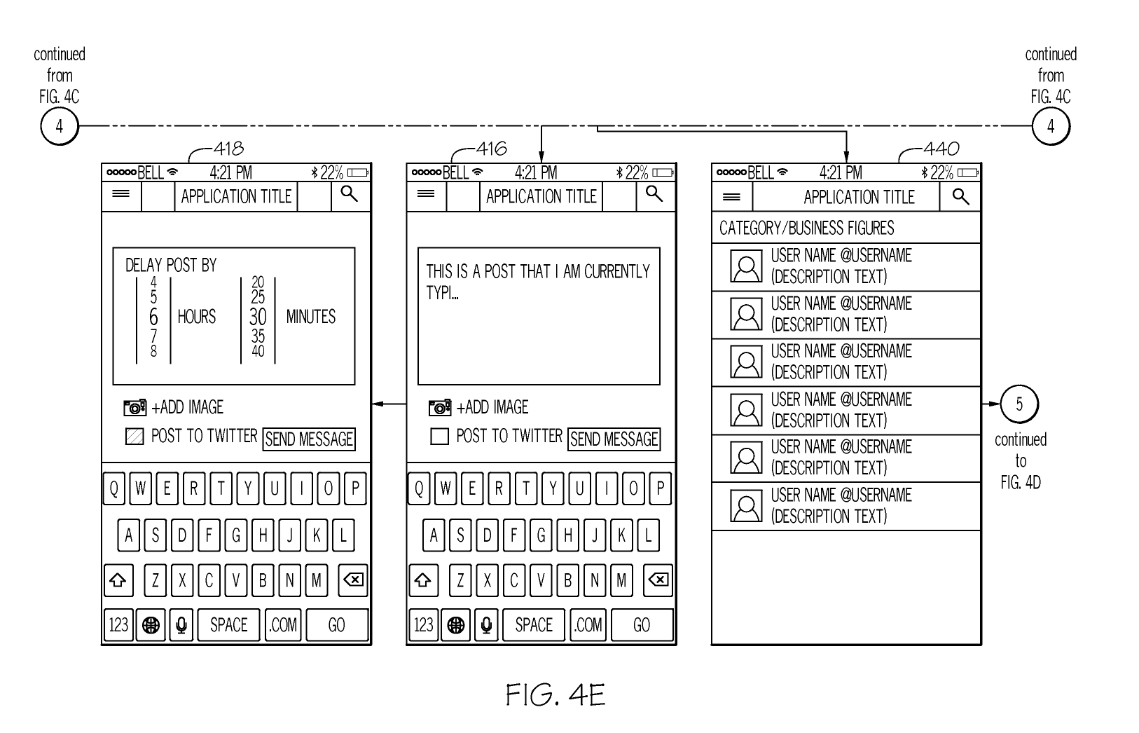

Referring now to FIGS. 4A-4E, a flowchart 400 will be discussed that illustrates an example interface for a source content provider, such as a celebrity. The interface 400 may include a login screen. (Block 402). After engaging the login screen at Block 402, the system may direct a source to a request to link to a social networking account (Block 404). The system may next direct the source to a landing screen shown in Block 406, which may include a title of the application, trending stores and sources, and updates for sources.

From the landing screen at Block 406, the user may access a side bar. (Block 410). The side bar may be expanded to display a menu of accessible feature. (Block 412). The source may engage the menu at Block 412 to access additional screens. For example, a source may access various screens summarizing posts from other popular content sources. (Block 414). Additionally, the source may access a text entry screen to submit a new post for view by subscribers. (Block 416). From the new post screen of Block 416, the source may define a delay period between posting on the system of the present invention and providing the post on a third-party platform. (Block 418).

From the landing screen shown at Block 406, the source may navigate to a viewing page, from which the source may view content of interest. (Block 420). The source may access a reply screen from the viewing page of Block 420 and submit a comment to the post. (Block 422).

From the landing screen shown at Block 406, the source may additionally navigate to a contact list. (Block 430). The contact list may include a search feature. From here, the source may navigate to an expanded list of contacts. (Block 432).

From the menu illustrated in Block 412, the source may select a group of sources through which to browse. (Block 440). Illustrative groups may include, but should not be limited to, business figures, companies, gurus, movies, TV, radio, musicians, political figures, athletes, and other sources.

From at least Blocks 432 and 440, the source may select a contact from the list of contacts to view that contact's information and optionally engage the contact. (Block 450). The contact may be a source or a subscriber. Additionally, after engaging at Block 450, the source may receive email with links to a website. (Block 452). A login may be required to confirm addition of the contact. The interface may also include a module for entering post information, a delay module relating to the information, a settings menu, profile information for other users and content providers, and other modules and interface components for use by a content provider. Additional features of the interface are illustrated by the flowchart 400 of FIGS. 4A-4E. Furthermore, additional features of the interface not illustrated by the flowchart would be appreciated by a skilled artisan.

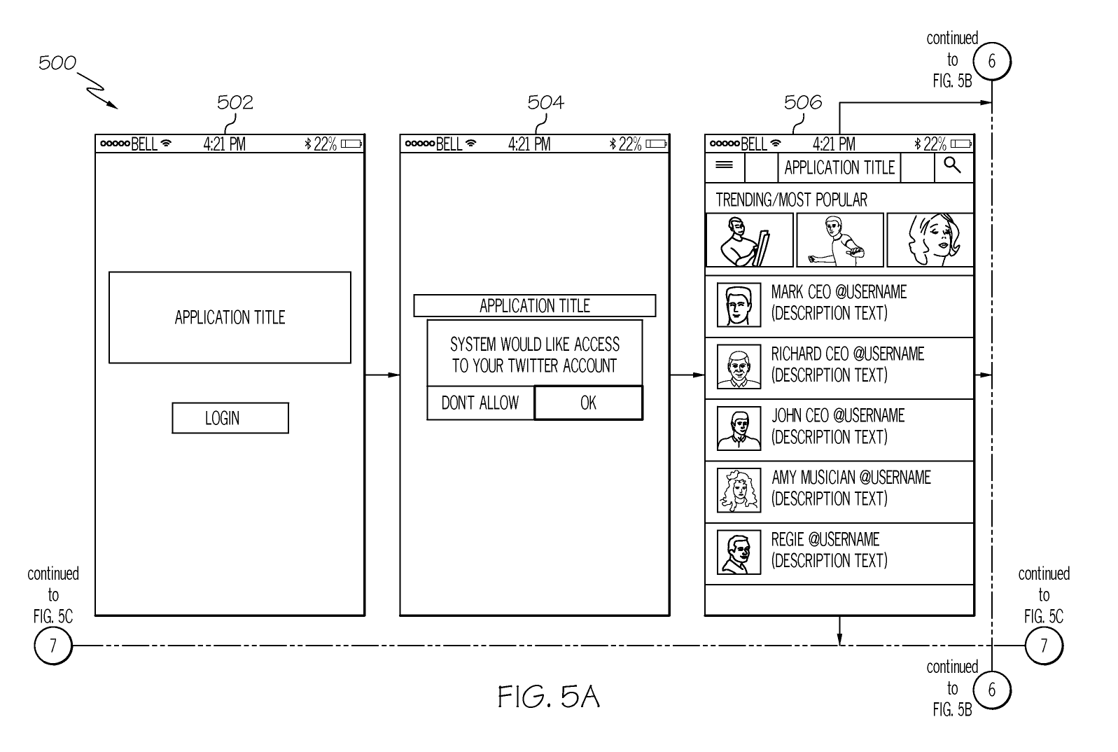

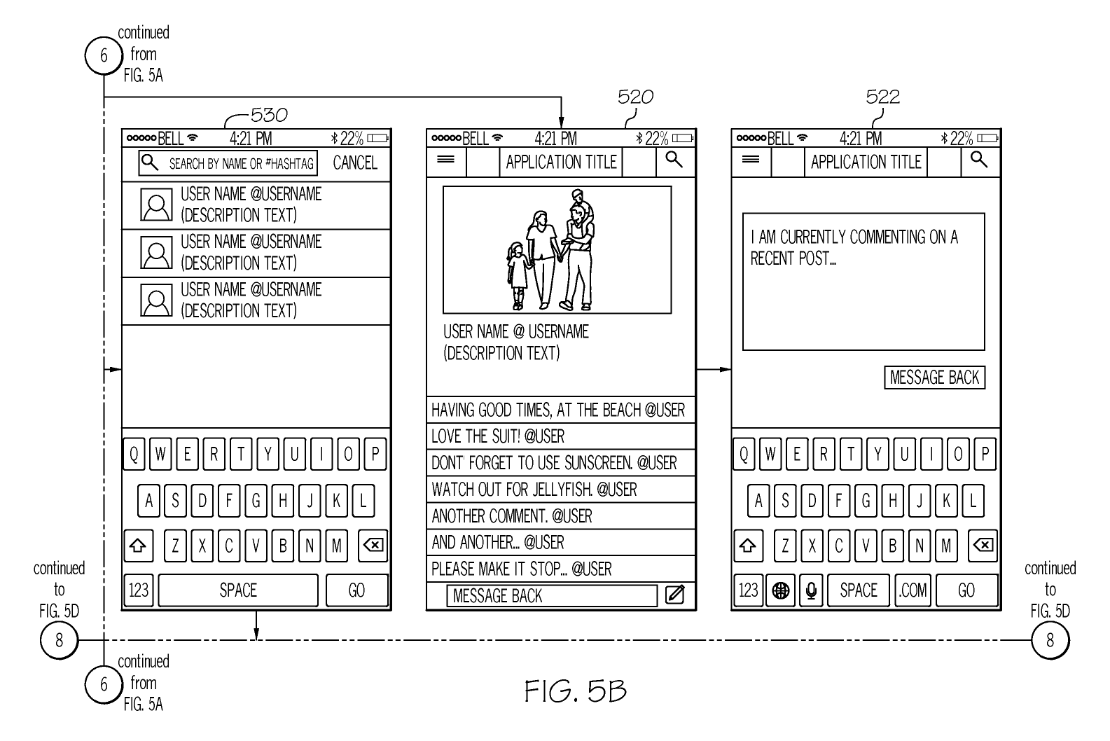

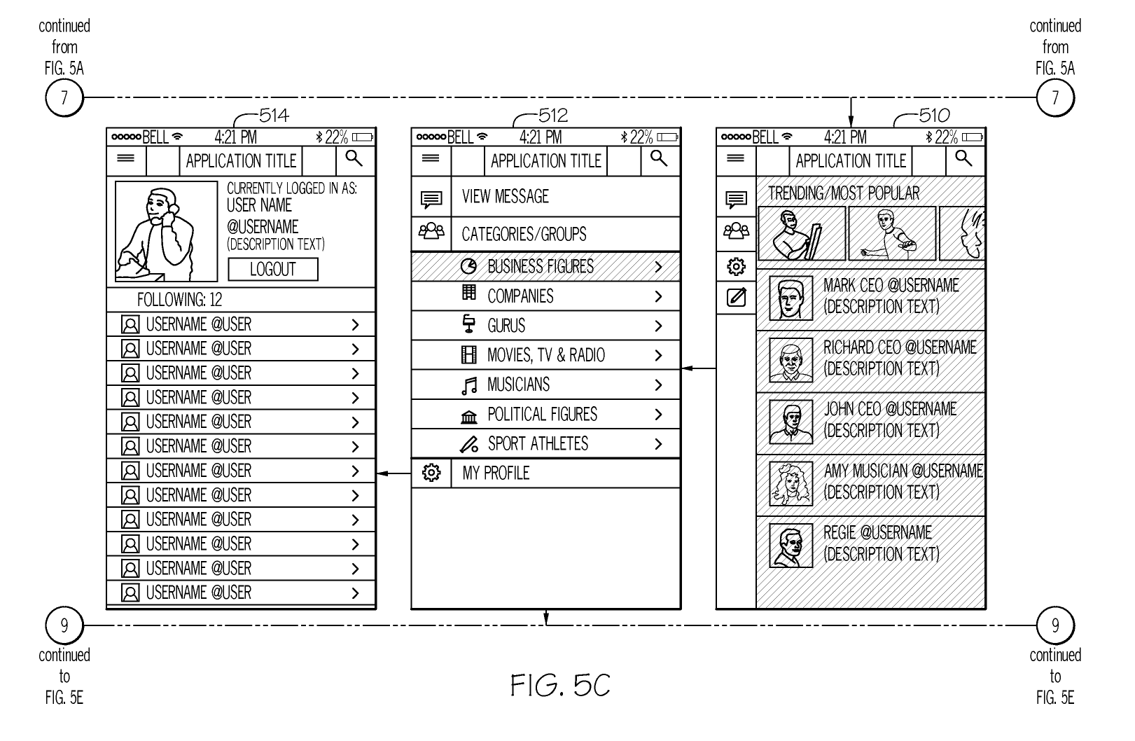

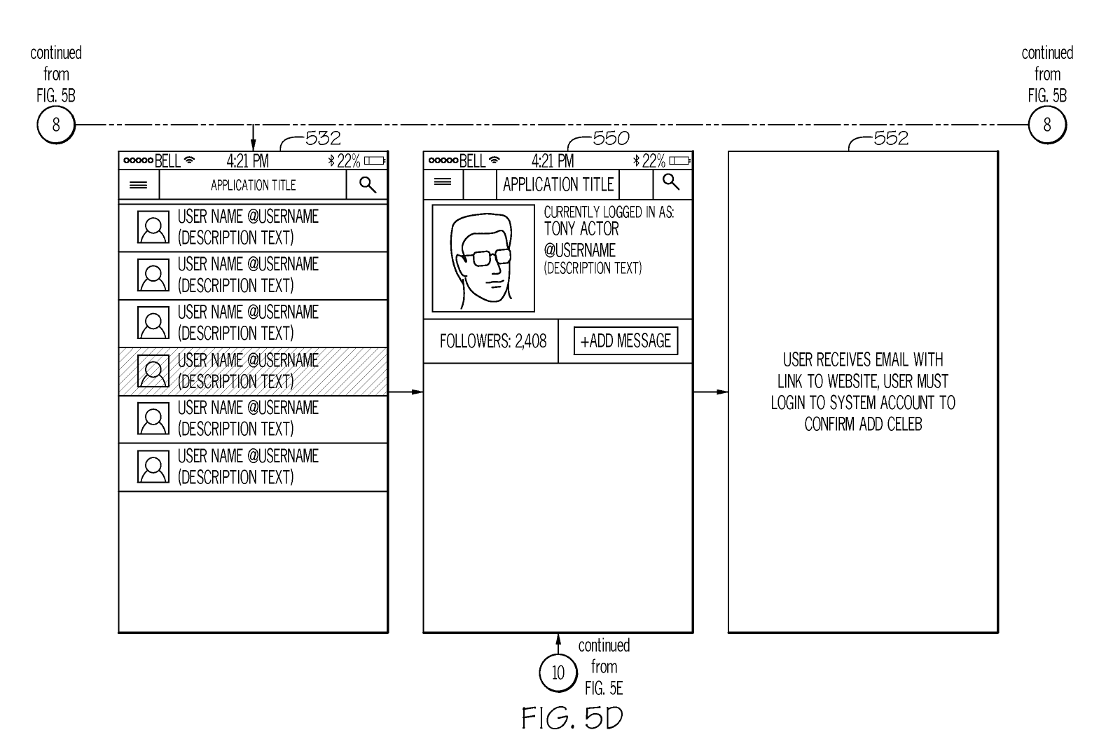

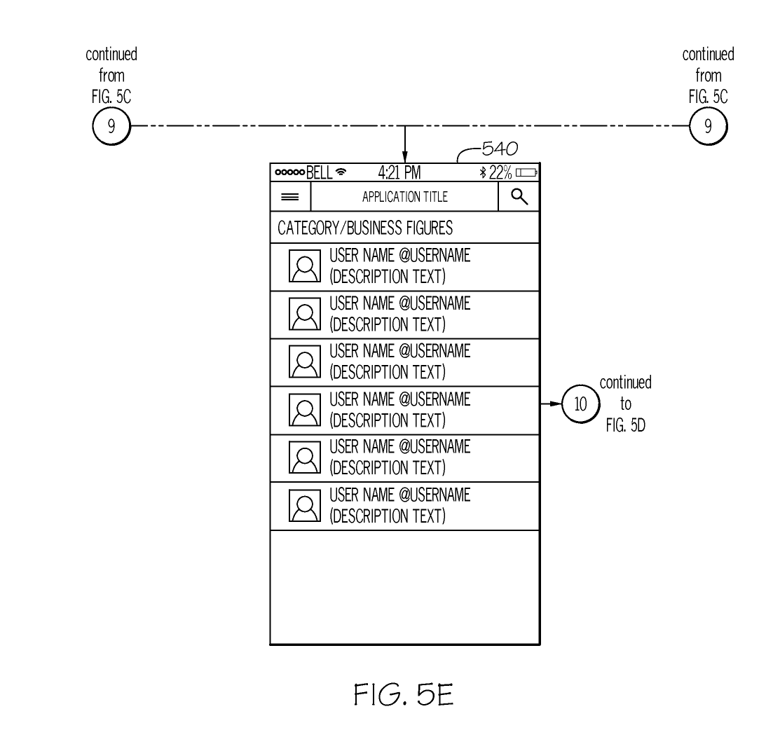

Referring now to FIGS. 5A-5E, a flowchart 500 will be discussed that illustrates an example interface for a subscriber. The interface 500 may include a login screen. (Block 502). After engaging the login screen at Block 502, the system may direct a subscriber to a request to link to a social networking account (Block 504). The system may next direct the subscriber to a landing screen shown in Block 506, which may include a title of the application, trending stores and sources, and updates for sources.

From the landing screen at Block 506, the user may access a side bar. (Block 510). The side bar may be expanded to display a menu of accessible feature. (Block 512). The subscriber may engage the menu at Block 512 to access additional screens. For example, a subscriber may access various screens summarizing posts from other popular content sources. (Block 514).

From the landing screen shown at Block 506, the subscriber may navigate to a viewing page, from which the subscriber may view content of interest. (Block 520). The subscriber may access a reply screen from the viewing page of Block 520 and submit a comment to the post. (Block 522).

From the landing screen shown at Block 506, the subscriber may additionally navigate to a contact list. (Block 530). The contact list may include a search feature. From here, the subscriber may navigate to an expanded list of contacts. (Block 532).

From the menu illustrated in Block 512, the subscriber may select a group of sources through which to browse. (Block 540). Illustrative groups may include, but should not be limited to, business figures, companies, gurus, movies, TV, radio, musicians, political figures, athletes, and other sources.

From at least Blocks 532 and 540, the subscriber may select a contact from the list of contacts to view that contact's information and optionally engage the contact. (Block 550). The contact may be a source or a subscriber. Additionally, after engaging at Block 550, the subscriber may receive email with links to a website. (Block 552). A login may be required to confirm addition of the contact. The interface may also include a module for entering post information, a delay module relating to the information, a settings menu, profile information for other users and content providers, and other modules and interface components for use by a content provider. Additional features of the interface are illustrated by the flowchart 500 of FIGS. 5A-5E. Furthermore, additional features of the interface not illustrated by the flowchart would be appreciated by a skilled artisan.

According to an embodiment of the present invention, the system may include a marketing module. The marketing module may collect data and/or information from users and/or content providers. Data and/or information may include names, contact information, email address, interests, content providers being followed, events attended, and other information that could be used for marketing purposes. The information may be used for targeted advertising, such as by providing a targeted advertisement. Advertising may be performed directly and/or by a third party, and may be monetized via an advertising fee paid by an advertiser.

In an embodiment of the present invention, the system may allow a subscriber to capture email as part of a workflow, allowing downloading and sending of the emails from a dashboard. This feature may include an optional field requesting the subscriber's email address after subscribing to his or her first source. The system may store the email addresses captured in a database. A list of email address may be exportable via an easily accessible format, for example, comma separated values (CSV). Email address listings may be included in an administrative dashboard with CSV export generation. Opt-in language may be included in the email request window to the subscriber.

The system may additionally include customizable subscriber and/or source profiles. Additional features may be added and/or activated for subscribers. An interface of the system may be scaled respective to a user's device used for access, for example, smartphone, tablet, or computer. A user may be facilitated in creating a profile and adjusting settings, for example, selecting from a dark background or a light colored background. A notification counter may notate an amount of unchecked notifications on the app tile. The notification counter may be displayed on an app icon and dynamically update when a source the subscriber is following posts an update or other content. Customizable features may additionally include light/dark design view selection capability, ability to create a custom username, ability to upload a profile picture, ability to refresh the app via pull-down, and other profile settings.

Feedback can be provided to a user regarding an anticipated exclusivity or delay between being able to view the information as a subscriber or as a non-subscriber member of the general public. For example, the information may be posted to a social networking service, such as Twitter, after a delay from when subscribers of the system receive access their earlier initial access. The delay may be definable by a source. As an example, delayed messages may be added as an option via a teaser message section of the source's interface. Teaser messages may be posted to a third party service to entice a potential subscriber to join the system and see the full message. Posting a delay message may provide feedback to a source that the message was successfully posted by the system and will be posted to the third party service after a delay. As an example, without limitation, feedback language may include, “[Messages] are available in [6] hour/s on [the third party service]. Click here to see it now!”

Feedback may also be provided to a source to determine how many subscribers receive their information. The feedback may allow sources to export the list of email addresses of subscribers that have followed them and/or currently follow them via CSV. The feedback information may include a source hyperlinked icon with embed code. The dashboard may inform a source of a number of subscribers, number of messages or other content posted, number of messages sent via the system to third party social networks, and other information. The categories may be capable of being printed.

Sources may be searchable by non-subscribers using the system. Sources can be recommended to a subscriber based on interests, which may be determinable by analyzing usage data. Some sources may be offered to a subscriber at discounted or free rates. A channel of communication may be opened between the subscriber and the source, for example, direct messaging via a communication feature.

The system may include additional features for subscribers, such as administrative functions, source grouping, thumbnail previews, favorite sources, search, indications as to the displayed status and/or exclusivity of information, state saving, multiple accounts, polls, surveys, links, and web browsing. The system may also allow sources to act as subscribers and follow other sources.

Marketing of both information (for example, political or social cause messages) and goods and services related to the celebrity or his or her endorsements can be made using the system to subscribers since such subscribers would be known to have a heightened interest in the source by virtue of having become a subscriber.

In an embodiment of the present invention, the system may include direct messaging features between subscribers and sources. The direct messaging features may be included by the communication features. The direct messaging features may include ability for subscribers to send a direct message to a source. The direct messaging feature could be monetized for a guaranteed response and/or included just as a feature to market the app. The direct messaging feature may be potentially monetized by charging sources for that position.

The direct messaging features may include ability for the subscriber to send a direct message to a source. Each subscriber may have a limit of direct messages he or she can send in a billing cycle, for example, four direct messages per month. The subscriber may purchase additional direct messages as desired. Pricing for additional direct messages may optionally be determined by a source. Limit on direct messages per month may be changed by a source or system administrator. Direct messages may include text, image, video capabilities, and other formats. Sources may view and reply to a subscriber's direct message.

In an embodiment of the present invention, the system may provide sources with data and analytics regarding fan equity, or valuation of subscribers. The system may allow a source to capitalize on fan equity by acquiring invaluable and previously unobtainable levels of data collection on fans. The system may also provide sources with access to a verified group of dedicated fans. As a user acquires additional fans, the user may capitalize on his or her fan base via sharing of subscription revenue. Additionally, sources may use the data collected from his or her fan equity to develop targeted marketing outreach, provide exclusive rewards to fans, and tailor comments exclusive to subscribers.

Sources may capitalize on fan equity by leveraging fans willing to subscribe to the source's feeds. Unlike competing social networking and messaging platforms, the system of the present invention advantageously allows collection of subscriber and follower email addresses and data that can be used to develop targeted marketing platforms. Sources may additionally use their fan equity to increase personal branding.

The system advantageously provides direct brand control, capitalization on fan equity, ownership of communication and data, and access to a platform for distributing exclusive content to subscribers and fans while still having access to their information for marketing purposes. Using the system of the present invention, a source may create personal connections with fans via messages before such connections may be made on competitor messaging platforms. The system of the present invention facilitates creating a loyal fan base instead of just accumulating casual followers. Additionally, the system of the present invention provides advertisers and endorsers with valuable data to increase monetization of a source's fan equity.

In an embodiment of the present invention, a source may provide priority content to one or more subscribers. Priority content may include early song releases, concert ticket sales, merchandise, product previews, news, breaking news, advance announcements, published content (including chapters, e-novellas, signed copies of works, exclusive content, etc.), and contests (character naming, etc.). Priority content and other content provided by a source may be used to increase the source's relevant career and social presence. For example, an athlete may have acquired a substantial fan base but has aged past his or her physical peak. With the assistance of the system of the present invention, this athlete can advantageously maintain relevance in the minds of his or her fans by providing information and priority content as a source.

In an embodiment of the present invention, the source may upload and/or distribute mixed media content. For example, a source may upload audio, video, images, interactive applications, and other media content. Sources may additionally sell advertisements directly in a subscriber channel, such as a delivery channel. A source may additionally create polls, surveys, and other interactive information gathering interfaces to acquire additional information from subscribers. These information-gathering tools advantageously provide data that is otherwise difficult or impossible to acquire, substantially benefitting creation of marketing efforts.

The video upload feature may provide a source a platform to upload a video for distribution using the system. The source may upload a video of an allowable length, for example, without limitation, 30 seconds, in various formats. The videos may optionally be restricted to commonly formats compatible with third-party messaging platforms, such as Instagram and Facebook, and may include *.mp4, *.wmv, *.mpg, *.mpeg, *.mov, *.avi, without limitation. The videos may be uploaded using a mobile or other application connected to the system.

According to an embodiment of the present invention, a multimedia feature may allow a subscriber to watch video and listen to audio within the system application. The system may optionally restrict sharing of some or all files. Commonly used audio file and video file formats may be attached to a message by a source. The system may allow a subscriber to play commonly used audio files and video files within the application of the system.

In an embodiment of the present invention, a source may additionally create custom URLs for its subscribers, providing easy access to subscriber accounts, source content, and/or other linked content. In one example, custom URLs may direct a non-subscriber to a celebrity preview page feature, which may allow non-subscribers to search for celebrities in the app. The custom URL platform may provide a source an ability to create a customer URL based on the source's username. The source may create a custom page layout with at least part of the information removed, which may act as a teaser for non-subscribers to create an account, subscribe, and view the full content.

In an embodiment of the present invention, the system may facilitate advertising via tracking dynamically trending content and topics. This feature may dynamically replace the trending section with advertisements, which may include language about purchasing a product. To implement dynamically trending advertising, the system may dynamically and systematically replace a trending information section, for example a trending celebrity section, with static advertisement and/or message that are hyperlinked. Advertisements and/or additional messages may be linked and displayed via the hyperlink.

In an embodiment of the present invention, the source may be provided database management features in the dashboard. Using these database management features, the source may easily manipulate the data collected from subscribers, acquire customized data sets of information relating to the subscribers, and perform analysis on such data. In further embodiments, the system may include in-app purchasing of content, subscriptions, and other forms of monetization. In-app purchasing may additionally include tickets, merchandise, media, exclusive access, and other content.

In an embodiment of the present invention, a subscriber may be offered an elevated membership status. This elevated status may be labeled, for example, “Platinum Membership.” Elevated status may provide additional benefits to a subscriber or other member, for example, including a number of source channels to which the elevated subscriber may subscribe without incurring additional fees.

In one embodiment of elevated membership status, the elevated status may be provided to sources with no payment required. An elevated member may select sources to follow based per request. To use the elevated membership feature, an invited source or subscriber may select sources to follow from the system dashboard. In this example, an elevated member is defined as a user of the system that can follow a configurable amount of celebrities from one to all (unlimited), without requiring payment. Additionally, elevated members may bypass in-app purchases. Elevated members may determine the sources to follow via system administrative dashboard.

In another embodiment, an active trending feature may be included to provide trending listings based on sources that are currently popular from multiple posts or content submissions. Trending listings are potentially monetized by charging sources for that position. Sources may be invited to participate in the active trending feature. An administrator or the system may determine sources that are the most active and display the appropriate profile picture associated with that source. The system may additionally determine sources that have similarities to the subscriber's current list of followed sources.

In another embodiment of the present invention, a recommended listings feature may recommend listings based on a subscriber, their interests, and the sources they have chosen to follow. The recommended listings feature may determine sources that have similarities to the subscriber's current list of followed sources. A list of the determined similar sources may be displayed on a part of the interface, for example, a sidebar. This feature may optionally be disabled by an administrator and/or subscriber.

In an embodiment of the present invention, a new celebrities feature may be included by the system to display a listing of the new celebrities that have been added as sources to system network. The newly added sources may be displayed on the sidebar discussed above.

The new celebrities feature may display some or all recent new sources that are added to the system network. Sources may be removed from a subscriber's new celebrities listing as the subscriber adds the new source to his or her subscription. This feature may optionally be disabled by an administrator and/or subscriber.

In another embodiment, a system admin dashboard may be used to promote a subscriber to a source by a system administrator. The system admin dashboard may be accessed by the system administrator via a dedicated login interface. The system admin dashboard may be browser-based and may allow the system administrator to view all subscribers in the system. Using the system admin dashboard, the system administrator may upgrade a subscriber to a source, elevated member, or other designation. The system admin dashboard may include information relating to a number of followers, number of messages on the system platform, number of messages on a third-party platform sent via the system by each source. Information may be presented individually, globally, and via another filtered metric. Information and categories may be capable of printing.

In an embodiment of the present invention, a custom group feature may be included to add a completed roster as a new category on the sidebar. The roster may include a group of sources. The roster may be named and may be presented as a category on the sidebar.

In an embodiment of the present invention, an image preview feature may display a thumbnail of the image in a message or other content distributed by a source. The thumbnail may be an image of a message or content, and may be attached to a standard message. Thumbnails may be displayed in various locations throughout the dashboard, interface, and/or system.

In an embodiment of the present invention, a favorite feature may be provided to enable the subscriber to mark a message or content as a favorite. The subscriber may click on an icon, for example a star-shaped icon, to mark the message as a favorite.

In an embodiment of the present invention, a search feature may be provided to search within the system for virtually all data and/or a limited set of data. The search feature may search through source and/or subscribers by username with the system, username with third-party platforms, hashtag, labeling, tags, and other user definable indications.

In an embodiment of the present invention, a visual indication may be provided that response that a message on a third-party platform has been processed within the system of the present invention. The notification may be displayed to the source that a message or other content has been posted to the third-party platform successfully. An icon may also be displayed confirming that a wink has been posted to the system of the present invention.

In an embodiment of the present invention, a cache feature may be provided to store recently browsed content in memory, advantageously speeding up an application used to access the system. For example, a user closes the application used to access the system and reopens the application; the system may return the user to where he or she left off. To implement this feature, short-term memory may be created when opening and closing the application.

According to an embodiment of the present invention, a multiple account feature may be provided to toggle between login accounts within the application. In one example, the multiple account feature may allow a subscriber to switch between up to three accounts within the application. The multiple account feature may advantageously eliminate the need to log off the application to change login subscriber accounts.

In an embodiment of the present invention, a survey feature may provide a platform for a source to post polls and /or surveys. The survey feature may allow the source to create and display a notification that a survey has been posted and provide subscribers access to respond. For example, the source may create a poll, which may media capable, to present four answers from which a subscriber may select a response. Results may be presented after selection is made.

In an embodiment of the present invention, a source follow feature may provide ability for sources to follow other sources. The source follow feature may provide an additional feed screen for the source's dashboard with the same capability as provided to a subscriber.

In another embodiment of the present invention, a hyperlinked icon may be provided to distribute source-paged hyperlinked logos. Sources may have a hyperlinked logo that is specific to their page. This feature could contain an embed code. This feature may also include a preview page for non-subscriber system members. This feature may be available on the source dashboard. The hyperlink icon may be used to provide recommendations with posting on additional messaging and/or social networking platforms.

In another embodiment of the present invention, an in-app browser may be included to navigate external content on a network, for example, the Internet. By providing an in-App browser, the system may advantageously reduce the likelihood that a subscriber may leave the application to see linked content posted in the system. The in-app browser may allow a user to view virtually all webpages that are linked to message from within in the system application.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for providing information comprising:
an interface for receiving the information from a source;
a delivery channel for transmitting the information to a subscriber; and
a commerce platform for monetization;
wherein the information is at least partially exclusive.

2. The system of claim 1, wherein the commerce platform comprises a billing engine to receive payment from the subscriber prior to providing access to at least part of the delivery channel.

3. The system of claim 2, wherein the billing engine generates revenue from the subscriber via a subscription to view the information from the source.

4. The system of claim 3, where the subscriber is provided access to a first subscription for a first subscription fee and a second subscription for a second subscription fee, wherein the payment from the subscriber comprises the first subscription fee and the second subscription fee.

5. The system of claim 1, wherein being at least partially exclusive comprises a delay period in which the subscriber has access to the information excluded from a non-subscriber, and wherein after the delay period the non-subscriber is provided the access to the information.

6. The system of claim 1, the commercial platform further comprising an advertising platform to display an advertisement for an advertising fee paid by an advertiser.

7. The system of claim 6, wherein the advertisement is displayable in the delivery channel.

8. The system of claim 1, the interface comprising a dashboard to display the information to the subscriber.

9. The system of claim 8, wherein the dashboard displays the information comprising trending content from sources.

10. The system of claim 1, wherein the subscriber is definable to have an elevated membership status that provides additional benefits.

11. The system of claim 1, further comprising data collected relating to the subscriber, wherein the data is presentable to the source, and wherein the data is indicative of fan equity.

12. The system of claim 11, wherein ownership of the information provided by the source and the data collected relating to the subscriber is provided to the source.

13. The system of claim 1, the interface comprising a browser to view media content without leaving the system.

14. The system of claim 1, wherein feedback relating to exclusivity is provided to the subscriber.

15. The system of claim 1, further comprising a communication feature to open a channel of communication between the subscriber and the source.

16. A system for providing information comprising:
an interface for receiving the information that is at least partially exclusive from a source;
a delivery channel for transmitting the information to a subscriber;
a commerce platform for monetization comprising a billing engine and an advertising platform; and
data collected relating to the subscriber;
wherein the data is presentable to the source;
wherein the data is indicative of fan equity.

17. The system of claim 16, wherein the source is locatable by a non-subscriber.

18. A method for transmitting information comprising:
(a) receiving the information from a source;
(b) determining a subscriber to the source; and
(c) transmitting the information to the subscriber;
wherein the information is at least partially exclusive.

19. The method of claim 18, further comprising (d) providing feedback relating to exclusivity to the subscriber.

20. The method of claim 18, further comprising (e) opening a channel of communication between the subscriber and the source.
